(19) United States
(12) Patent Application Publication
(10) Pub. No.: US 2026/0316240 A1
(43) Pub. Date: Oct. 15, 2026

(54) NAIL GUN

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/119,134

(22) PCT Filed: Jul. 30, 2024
(86) PCT No.: PCT/CN2024/108508

§ 371 Date: Apr. 8, 2025

(30) Foreign Application Priority Data
Sep. 19, 2023 (CN) 202322549205.2
Sep. 19, 2023 (CN) 202322550376.7
Sep. 19, 2023 (CN) 202322552269.8

(51) Int. Cl. B25C 1/00; B25C 1/06

(52) U.S. Cl. CPC B25C 1/008; B25C 1/005; B25C 1/06

(57) ABSTRACT

Provided are a nail gun, a no-nail protection structure for a nail gun, a motor stop structure for a nail gun, and a nail gun with a magazine easy to assemble and disassemble. The nail gun includes a shell, a magazine, a control chip, a cam, a connecting rod, a first inductive sensor, a third inductive sensor, a sensing block and a nail shooting structure, where the magazine is detachably connected to the shell. The nail gun further includes a protection portion, the protection portion includes a trigger element, a first spring, a trigger switch and a clamping piece, the clamping piece is arranged in the magazine, an anti-dry firing nail block is arranged at the top of the clamping piece, a clamping portion corresponding to the anti-dry firing nail block is arranged on the trigger element, and a clamping structure is arranged on an outer side of the magazine.

### CROSS REFERENCE TO THE RELATED APPLICATIONS

This application is the national phase entry of International Application No. PCT/CN 2024/108508, filed on Jul. 30, 2024, which is based upon and claims priority to Chinese Patent Application No. 202322549205.2, filed on Sep. 19, 2023, Chinese Patent Application No. 202322552269.8, filed on Sep. 19, 2023, and Chinese Patent Application No. 202322550376.7, filed on Sep. 19, 2023, the entire contents of which are incorporated herein by reference.

### TECHNICAL FIELD

The invention relates to the technical field of nail guns, in particular to a no-nail protection structure for a nail gun, a motor stop structure for a nail gun and a nail gun, and a nail gun with a magazine easy to assemble and disassemble.

### BACKGROUND

A nail gun is a decoration tool used for driving nails in a specific shape into components to be mounted. According to the type of power adopted by nail guns, there are electric nail guns, pneumatic nail guns, gas nail guns and manual nail guns, wherein the electric nail guns and the pneumatic nail guns are used widely. The pneumatic nail guns obtain a high air pressure mainly by means of an external air pump to provide power for nails in a channel. The electric nail guns control a firing pin to contract mainly by means of a motor to compress an energy storage part matched with the firing pin, such as a spring or a gas tank and then releases the firing pin to hit nails. Compared with pneumatic nail guns, the electric nail guns are smaller in overall size and easy to carry and can be provided with an independent power supply, thus having a board application prospect.

As for existing electric nail guns such as the nail gun disclosed by Patent Authorization and Publication No. CN212287494U, structures such as a power source and a firing pin are arranged in the nail gun to implement set operations, and a photoelectric sensing device is arranged to detect the number of remaining nails to guarantee the safety of the nail gun in use. However, in use, nails may be used up without being detected. Therefore, a safe and effective no-nail protection structure for a nail gun is needed.

As for existing electric nail guns such as the nail gun disclosed by Patent Authorization and Publication No. CN212287494U, structures such as a power source and a firing pin are arranged in the nail gun to implement set operations, and a photoelectric sensing device is arranged to detect the number of remaining nails. However, this patent only involves no-nail protection of the nail gun, and does not take into account the start and stop positions of the firing pin. In a traditional electric nail gun, due to the inertia of a power source after the power source is stopped, it is difficult to control the start and stop positions of the firing pin connected to the power source, making it difficult to control the state of the firing pin when the firing pin is started later and also making it difficult to accurately determine whether the firing pin hits against a nail. Therefore, a motor stop structure and a nail gun that can realize control of the position of the firing pin are needed.

In existing electric nail guns, a magazine and a body are often threadedly connected to realize stable connection. For example, Patent Authorization and Publication No. CN214723920U discloses an anti-dry firing device for a nail gun and a nail gun, and as shown by the drawings, a magazine is threadedly connected and fixed to the nail gun. In existing nail guns, the magazine threadedly connected to the body is difficult to assemble and disassemble, and an extra assembling and disassembling tool is needed to remove the threaded connection structure, leading to much inconvenience in maintenance, storage, carrying or other cases where the magazine needs to be disassembled. In view of this, a nail gun with a magazine easy to assemble and disassemble is needed.

### SUMMARY

The objective of the invention is to overcome the defects in the prior art by providing a no-nail protection structure for a nail gun.

To solve the above problems, the invention adopts the following scheme:

A no-nail protection structure for a nail gun includes a shell, a magazine and a nail shooting portion, wherein the nail shooting portion is arranged in the shell and includes a firing pin and a power source; the firing pin is connected to the power source; the magazine is detachably arranged on the shell; the no-nail protection structure further includes a protection portion; the protection portion includes a trigger element, a first spring, a trigger switch and a clamping piece; wherein, the trigger element is slidably arranged in the vicinity of a nail shooting opening in the shell; the first spring is arranged between the trigger element and the shell; the trigger switch is arranged on a sliding path of the trigger element; the trigger switch is connected to the power source; the clamping piece is arranged in the magazine, and an elastic element is arranged between the clamping piece and the magazine; an anti-dry firing nail block is arranged at a top of the clamping piece, and a clamping portion corresponding to the anti-dry firing nail block is arranged on the trigger element.

Further, the trigger switch is a touch switch or a photoelectric switch.

Further, the trigger element includes a safety lever and an adjusting block; the safety lever is arranged on the shell, and the adjusting block is arranged at a position close to the nail shooting opening of the shell; the adjusting block is disposed around the safety lever by means of a threaded structure.

Further, the adjusting block is a semicircular and arranged on an outer side of the nail shooting opening of the shell of a nail gun and slides along an outer wall of the nail shooting opening.

Further, the first spring is disposed around an outer side of the safely lever.

Further, a nail pusher for pushing nails is arranged in the magazine, and the clamping piece is fixedly arranged on the nail pusher.

Further, the elastic element is a coil spring or a second spring.

Further, at least one through-hole for observing the number of remaining nails in the magazine is formed in a side face of the magazine.

The invention has the following beneficial effects:

the clamping piece is arranged in the magazine and works together with the trigger element and the trigger switch, and when nails in the magazine are used up, the trigger element can be clamped to prevent the power source from acting, such that physical no-nail protection is realized, the structure is simple, and the effect is table;

the trigger element includes the safety lever and the adjusting block, and the threaded structure is arranged between the safety lever and the adjusting block, such that the nail shooting depth of the nail gun can be adjusted;

the through-hole is formed in the side face of the magazine, such that the number of remaining nails in the magazine can be observed.

The invention further provides a nail gun with a magazine easy to assemble and disassemble.

To settle the above technical issue, the invention adopts the following scheme:

A nail gun with a magazine easy to assemble and disassemble includes a shell and a magazine, wherein the magazine is detachably connected to the shell; the magazine is in the shape of a rectangular box on the whole; a hollow structure for storing a row of nails is arranged in the magazine; a top of the magazine is connected to the shell; first clamping blocks extending outwards are arranged on two sides of the top of the magazine, and a first clamping groove corresponding to the first clamping blocks is formed in the shell; an opening of the first clamping groove faces a front side or a back side; a clamping structure is arranged on an outer side of the magazine; the clamping structure includes a shifter rotatably connected to the magazine, and a torsion spring, and the torsion spring is arranged between the shifter and the magazine; a second clamping block corresponding to the shifter is arranged on the shell.

Further, the first clamping blocks are strip-shaped, and an opening matched with the first clamping blocks is formed in the first clamping groove.

Further, ends, facing the first clamping groove, of the first clamping blocks are configured as arc surfaces.

Further, the opening of the first clamping groove faces forwards.

Further, the shifter is in the shape of a long plate on the whole, and a through-hole is formed in a portion close to the middle of the shifter; the shifter has an end clamped on the second clamping block as well as an end to be shifted.

Further, a barb is arranged at the end, close to the second clamping block, of the shifter, wherein the barb is in contact with an upper surface of the second clamping block.

Further, a bump matched with the torsion spring is arranged on the outer side of the magazine, and the clamping structure is located between the bump and the second clamping block.

Further, an end, away from the shifter, of the torsion spring is directly connected to a hole structure or a groove structure formed in the outer side of the magazine.

Further, two protrusive rectangular elongated blocks are arranged on an upper surface of the magazine and respectively located on two sides of a nail outlet of the magazine; second clamping grooves matched with the elongated blocks are formed in a bottom of the shell, and the elongated blocks are inlaid in the second clamping grooves.

Further, an elongated through-hole connected to the hollow structure in the magazine is formed in a side face of the magazine.

The invention has the following beneficial effects:
the clamping structure and the first clamping blocks are arranged on the magazine and respectively matched with the second clamping block and the first clamping groove on the shell, such that the magazine is detachably connected to the shell, and the magazine can be easily separated from the shell by rotating the shifter in the clamping structure;
the barb is arranged at the end, close to the second clamping block, of the shifter in the clamping structure, such that the situation where the shifter is separated from the second clamping block due to downward movement of the magazine is avoided;
the elongated blocks arranged on the upper surface of the magazine are matched with the second clamping grooves in the shell to further clamp the magazine on the shell, such that the magazine is prevented from shaking leftwards and rightwards.

The invention further provides a nail gun and a motor stop structure for a nail gun.

To solve the above problems, the invention adopts the following scheme:

A nail gun includes a motor stop structure for a nail gun and further includes a nail shooting structure and a shell, wherein the nail shooting structure includes a firing pin, a motor, a piston, a transmission gear set and a cylinder barrel; the firing pin, the motor, the piston, the transmission gear set and the cylinder barrel are arranged in the shell, the transmission gear set is connected to the motor and the firing pin, the cylinder barrel is arranged at an end, away from the motor, of the firing pin, and the piston connected to the firing pin is arranged in the cylinder barrel; a control chip, a cam, a connecting rod and a first inductive sensor in the motor stop structure are arranged in the shell; the cam in the motor stop structure is arranged on a shaft of the motor.

Further, the motor stop structure for a nail gun includes the control chip, the cam, the connecting rod and the first inductive sensor, wherein the cam is arranged on the shaft of the motor in the nail gun; the connecting rod is arranged between the cam and the first inductive sensor; the first inductive sensor and the control chip are arranged in a shell of the nail gun, and the first inductive sensor is connected to the control chip; an elastic structure for restoring the connecting rod is arranged between the connecting rod and the shell of the nail gun.

Further, the connecting rod includes a head rod, an intermediate rod and a tail rod; wherein, the intermediate rod is arranged between the head rod and the tail rod, and the head rod, the intermediate rod and the tail rod are formed integrally.

Further, the head rod is in the shape of a triangular plate on the whole and located in a same plane as the cam.

Further, a columnar hole matched with a spring is formed in an end of the tail rod.

Further, the tail rod is L-shaped, and an end, away from the intermediate rod, of the tail rod is in contact with the first inductive sensor and the elastic structure.

Further, the motor stop structure for a nail gun includes a third inductive sensor and a sensing block; the third inductive sensor is arranged corresponding to the sensing block, and the sensing block is located on a firing pin of a nail gun.

Further, the third inductive sensor is a photoelectric sensor or a Hall sensor.

Further, the nail gun further includes a trigger, wherein the trigger is rotatably arranged in the shell, a spring is arranged between the trigger and the shell, and a second inductive sensor is arranged corresponding to the trigger of the nail gun.

Further, the nail gun further includes the second inductive sensor used for counting the number of pulls of a trigger of the nail gun.

The invention has the following beneficial effects:
the motor stop structure for a nail gun includes the cam, the connecting rod and other structures, such that the rotation angle of the motor can be sensed to obtain the position of the firing pin in the nail gun, and the firing pin can be controlled to stop at a set position;
the head rod of the connecting rod is in the shape of a triangular plate and located in the same plane as the cam, such that the head rod can be kept in contact with the cam to the maximum extent, and the load capacity of the head rod can be improved to ensure that the head rod is unlikely to be damaged when reciprocating quickly with the cam;
the second inductive sensor is arranged to sense the press state of the trigger to determine whether the motor needs to be stopped; the first inductive sensor and the second inductive sensor are used to count the number of revolutions of the motor and the number of pulls of the trigger respectively to verify whether a nail gets stuck;
the third inductive sensor is arranged to sense the position of the sensing block to control the position of the firing pin, thus ensuring that the firing pin is located at a set position when the nail gun is started and stopped.

### BRIEF DESCRIPTION OF THE DRAWINGS

FIG. 1 is an overall diagram of a nail gun according to Embodiment 1;

FIG. 2 is an internal diagram of a shell of the nail gun according to Embodiment 1;

FIG. 3 is an enlarged view of area A in FIG. 2;

FIG. 4 is a schematic diagram of a magazine and part of a protection portion according to Embodiment 1;

FIG. 5 is an overall diagram according to Embodiment 2;

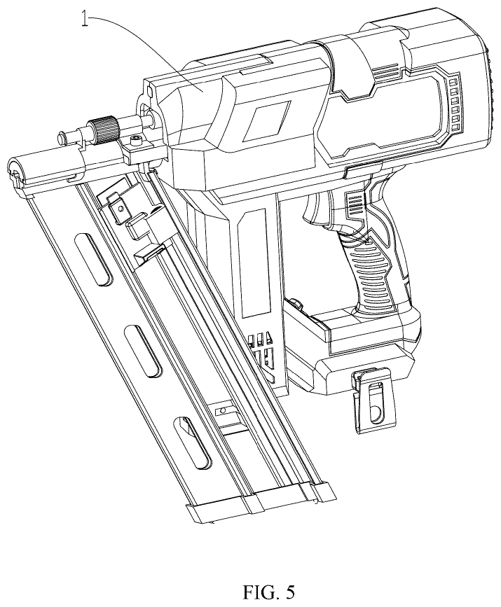

FIG. 6 is an internal structural diagram of a shell according to Embodiment 2;

FIG. 7 is a schematic diagram of a motor stop structure and part of a nail shooting structure according to Embodiment 2;

FIG. 8 is a schematic diagram of a motor stop structure and the nail shooting structure according to Embodiment 2;

FIG. 9 is a schematic diagram of the motor stop structure and a motor according to Embodiment 2;

FIG. 10 is a schematic diagram of a motor stop structure in a nail gun according to Embodiment 3;

FIG. 11 is an overall diagram of a nail gun according to Embodiment 4;

FIG. 12 is a front view of the nail gun according to Embodiment 4;

FIG. 13 is an assembled diagram of part of a shell and a magazine according to Embodiment 4;

FIG. 14 is a schematic diagram of the magazine according to Embodiment 4;

FIG. 15 is a schematic diagram of part of the shell matched with the magazine according to Embodiment 4.

Reference signs: 1, shell; 2, magazine; 21, nail pusher; 22, through-hole; 23, coil spring; 3, nail shooting portion; 31, firing pin; 32, power source; 4, protection portion; 41, trigger element; 411, safety lever; 412, adjusting block; 413, threaded structure; 42, first spring; 43, trigger switch; 44, clamping piece; 411, anti-dry firing nail block 2-1, cam; 2-2, connecting rod; 2-21, head rod; 2-22, intermediate rod; 2-23, tail rod; 2-3, first inductive sensor; 2-4, second inductive sensor; 1, shell; 2-6, nail shooting structure; 2-62, motor; 2-63, piston; 2-64, transmission gear set; 2-65, cylinder barrel; 2-7, trigger; 2-8, third inductive sensor; 2-9, sensing block.

3-11, first clamping groove; 3-12, second clamping block; 3-13, second clamping groove; 2, magazine; 3-21, first clamping block; 3-22, clamping structure; 3-221, shifter; 3-222, barb; 3-223, torsion spring; 3-23, bump; 3-24, elongated block.

### DETAILED DESCRIPTION OF THE EMBODIMENTS

The implementation of the invention is explained below by means of specific embodiments, and those skilled in the art can easily understand other advantages and effects of the invention with reference to the contents disclosed in the specification. The invention can also be implemented or applied by means of other different specific embodiments, and various modifications or transformations can be made to details in the specification based on different points of view and applications without departing from the spirit of the invention. It should be noted that the following embodiments and features in the following embodiments can be combined without conflicts.

It should be noted that drawings provided in the following embodiments are merely used to illustratively explain the basic concept of the invention, only show components related to the invention and are not plotted according to the actual number, shape and size of the components in actual implementation. In actual implementation, the form, number and scale of the components can be changed freely, and the layout of the components may be more complex.

### Embodiment 1

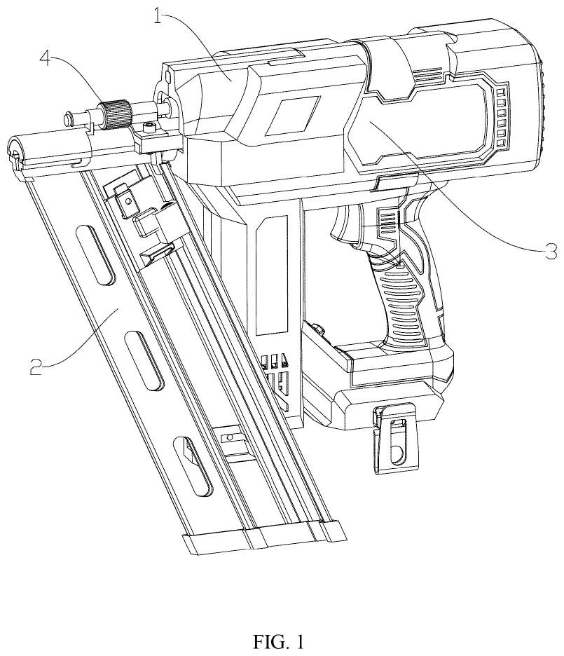

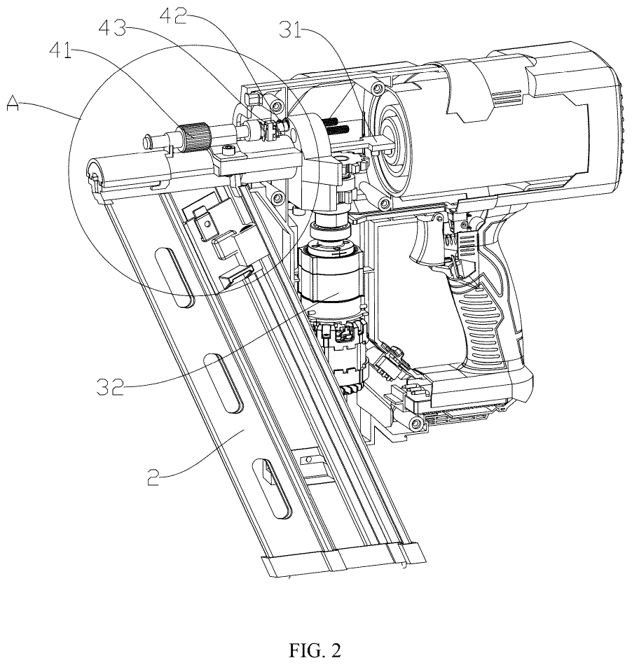

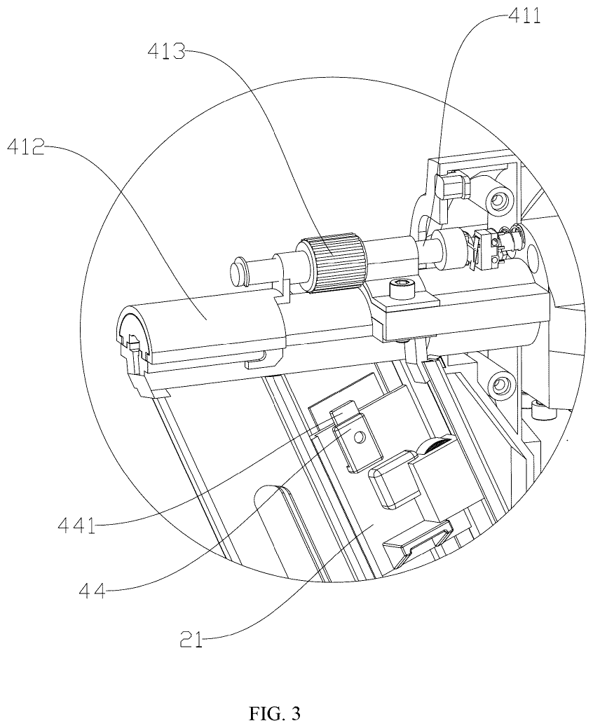

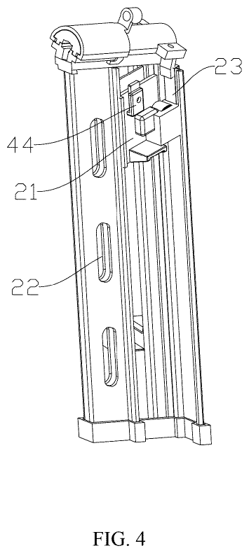

As shown in FIGS. 1-4, a no-nail protection structure for a nail gun includes a shell 1, a magazine 2 and a nail shooting portion 3, wherein the nail shooting portion 3 is arranged in the shell 1 and includes a firing pin 31 and a power source 32; the firing pin 31 is connected to a power source 32 and driven by the power source 32; the magazine 2 is detachably arranged on the shell 1; the no-nail protection structure further includes a protection portion 4; the protection portion 4 includes trigger element 41, a first spring 42, a trigger switch 43 and a clamping piece 44; wherein, the trigger element 41 is slidably arranged in the vicinity of a nail shooting opening in the shell 1. It should be noted that the nail shooting opening of the shell 1 is an opening by which the nail gun shoots out nails. In addition, in this embodiment, the sliding direction of the trigger element 41 is consistent with the nail shooting direction of the nail shooting opening. The first spring 42 is arranged between the trigger element 41 and the shell 1. In this embodiment, the first spring 42 is disposed around an outer side of the trigger element 41. The trigger switch 43 is arranged on a sliding path of the trigger element 41, such that the trigger element 41 can come in contact with the trigger switch 43 when sliding in the shell 1. The trigger switch 43 is connected to the power source 32. The clamping piece 44 is arranged in the magazine 2, an elastic element is arranged between the clamping piece 44 and the magazine 2 and provides a pushing force towards a nail outlet of the magazine 2 for the clamping piece 44, and the nail outlet of the magazine 2 is an opening for nails to be shot out of the magazine 2. A protrusive anti-dry firing nail block 441 is arranged at the top of the clamping piece 44, and a clamping portion corresponding to the anti-dry firing nail block 441 is arranged on the trigger element 41. When nails in the magazine 2 are used up, the anti-dry firing nail block 441 at the top of the clamping piece 44 will abut against the clamping portion on the trigger element 41 to lock the trigger element 41, such that the trigger element 41 will not move towards the trigger switch 43, and the power source 32 will not be started, thus realizing no-nail protection.

The trigger switch 43 is a touch switch or a photoelectric switch. In this embodiment, the trigger switch 43 is a touch switch. It should be noted that when the trigger switch 43 is not triggered, the power source 32 will not be started; only when the trigger switch 43 is started by pressing the trigger element 41, the power source 32 will be unlocked to act according to a received control instruction.

The trigger element 41 includes a safety lever 411 and an adjusting block 412; the safety lever 411 is movably arranged on the shell 1, and the adjusting block 412 is arranged at a position close to the nail shooting opening of the shell 1; the adjusting block 412 is disposed around the safety lever 411 by means of a threaded structure 413, and the threaded structure 413 is able to adjust the length of the adjusting block 412 extending out of the nail shooting opening so as to adjust the nail shooting depth of the nail gun. The length range of the adjusting block 412 extending out of the nail shooting opening is a set value. In this embodiment, the adjusting block 412 is semicircular and arranged on an outer side of the nail shooting opening of the shell 1 of the nail gun and slides along an outer wall of the nail shooting opening. It should be noted that to be specific, the safety lever 411 is slidably arranged on the shell 1, and the sliding length range of the safety lever 411 on the shell 1 is a fixed value; with the sliding of the safety lever 411, the trigger switch 43 will be triggered. In this embodiment, the first spring 42 is disposed around an outer side of the safety lever 411, and two ends of the first spring 43 respectively abut against the shell 1 and a circular disc arranged on the safety lever 411.

A nail pusher 21 used for pushing nails is arranged in the magazine 2, an elastic element is arranged between the nail pusher 21 and the magazine 2, and the elastic element is a second spring or a coil spring 23. In this embodiment, the elastic element is a coil spring 23, the coil spring 23 is located on the nail pusher 21, and an end of the coil spring 23 clamps the top of the magazine 2. In this embodiment, the clamping piece 44 is fixedly arranged on the nail pusher 21, such that the elastic element arranged between the nail pusher 21 and the magazine 2 can also drive the clamping piece 44 to act. The clamping piece 44 is arranged corresponding to the adjusting block 412. In this embodiment, when the nail pusher 21 moves to the top of the magazine 2 (that is, nails in the magazine 2 are used up), the anti-dry firing nail block 441 on the clamping piece 44 is close to the outer side of the nail shooting opening of the shell 1 and located on the movement trajectory of the adjusting block 412 in the trigger element 41, such that the adjusting block 412 is clamped and prevented from moving towards the trigger switch 43. It should be noted that the protruding height of the clamping piece 44 on the anti-dry firing nail block 441 is adjustable. In this embodiment, the anti-dry firing nail block 441 and the clamping piece 44 are fastened by means of screws.

It should be noted that in some other embodiments, a clamping block matched with the anti-dry firing nail block 441 on the clamping piece 44 may be located on the safety lever 411. Wherein, the clamping block extending towards a side face of the safety lever 411 is arranged at an end, away from the trigger switch 43, of the safety lever 411. When nails in the magazine 2 are used up, the clamping piece 44 is located on the movement trajectory of the clamping block and abuts against the clamping block to prevent the clamping block from moving towards the trigger switch 43, such that no-nail protection is realized.

At least one through-hole 22 is formed in a side face of the magazine 2, and an approximate number of remaining nails in the magazine 2 can be observed by means of the through-hole 22.

In the implementation process, the clamping piece 44 is arranged in the magazine 2 and works together with the trigger element 41 and the trigger switch 43, and when nails in the magazine 2 are used up, the trigger element 41 can be clamped to prevent the power source 32 from acting, such that physical no-nail protection is realized, the structure is simple, and the effect is table; the trigger element 41 includes the safety lever 411 and the adjusting block 412, and the threaded structure 413 is arranged between the safety lever 411 and the adjusting block 412, such that the nail shooting depth of the nail gun can be adjusted; the through-hole 22 is formed in the side face of the magazine 2, such that the number of remaining nails in the magazine 2 can be observed.

### Embodiment 2

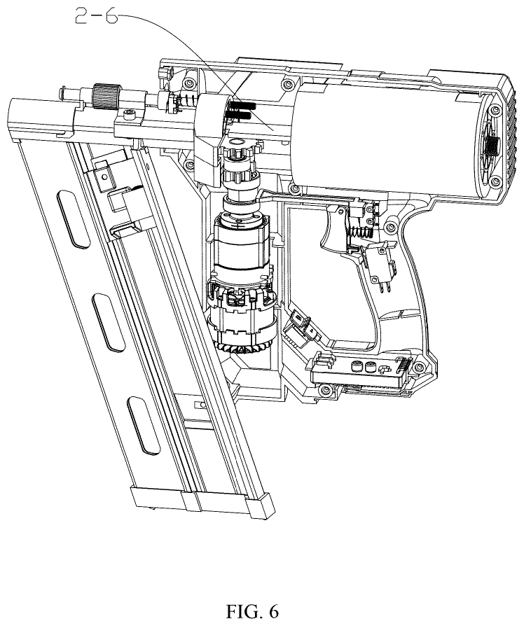

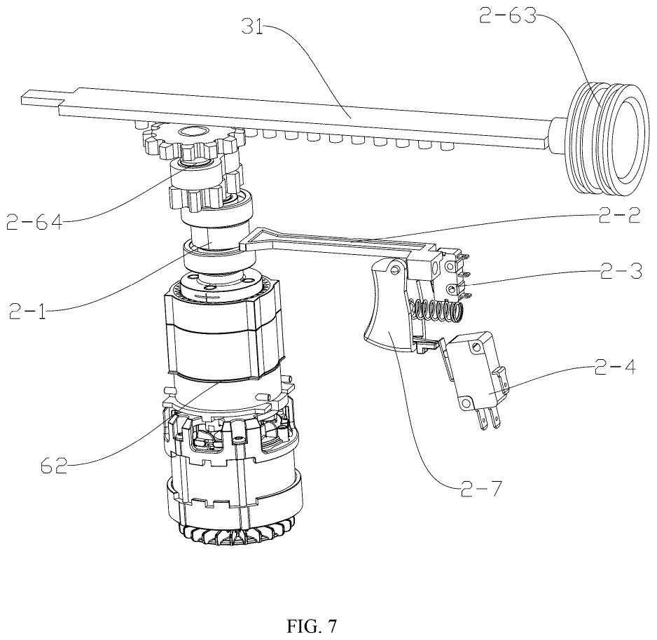

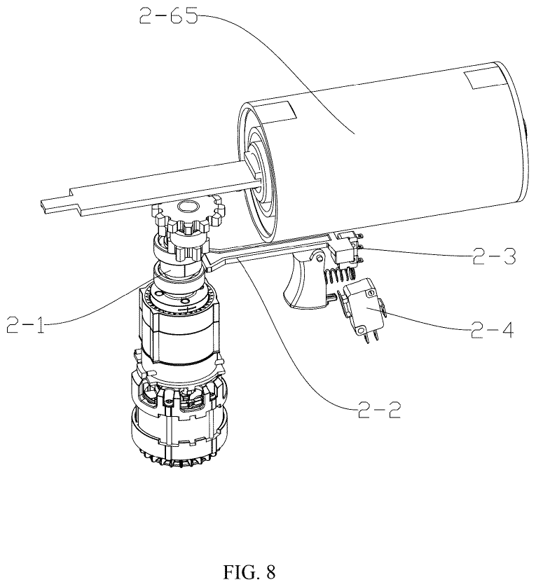

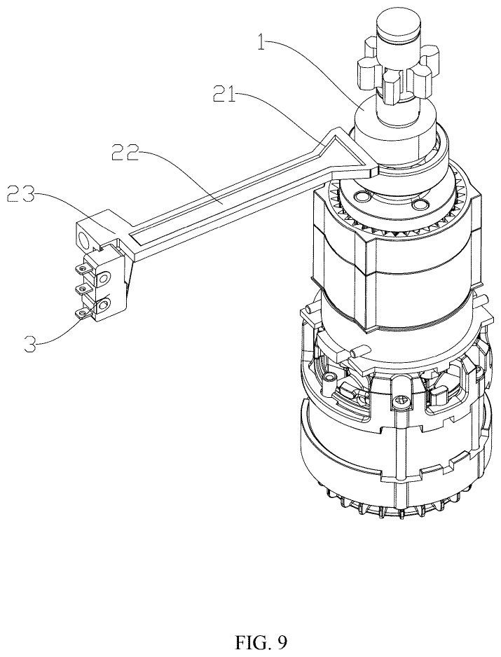

As shown in FIGS. 6-9, a motor stop structure for a nail gun includes a control chip, a cam 2-1, a connecting rod 2-2 and a first inductive sensor 2-3, wherein the cam 2-1 is arranged on a shaft of a motor 2-62 in a nail gun; the connecting rod 2-2 is arranged between the cam 2-1 and the first inductive sensor 2-3; the first inductive sensor 2-3 and the control chip are arranged in a shell 1 of the nail gun, and the first inductive sensor 2-3 is connected to the control chip; an elastic structure is arranged between the connecting rod 2-2 and the shell 1 of the nail gun and applies a force towards the cam 2-1 to the connecting rod 2-2 to drive the connecting rod 2-2 to restore. In the implementation process, the shaft of the motor 2-62 rotates to drive the cam 2-1 to rotate, and the cam 2-1, when rotating, pushes the connecting rod 2 and works together with the elastic structure to realize reciprocating motions of the connecting rod 2-2, such that the first inductive sensor 2-3 is triggered repeatedly; when the motor 2-62 stops, the shaft of the motor 2-62 will continue to rotate under the action of inertia, and the first inductive sensor 2-3 works together with the cam 2-1 to sense the attitude of the motor 2-62 to control the shaft of the motor to stop at a set angle, such that a firing pin 31 is controlled to stop at a set position, It should be noted that sensing of the rotation angle of the shaft of the motor by means of the inductive sensor and the cam is an existing technical solution, and the shaft of the motor 2-62 is controlled to stop by means of an existing technique, so it is feasible to control the motor to stop at the set angle by means of the first inductive sensor 2-3 and the cam 2-1 arranged on the shaft of the motor 2-62. For example, if the firing pin 31 completes one reciprocating motion every five revolutions of the motor 2-62, the motor 2-62 is controlled to stop when the first inductive sensor 2-3 senses five revolutions of the motor 2-62, such that the firing pin 31 can return to the initial position.

The connecting rod 2-2 includes a head rod 2-21, an intermediate rod 2-22 and a tail rod 2-23, wherein the intermediate rod 2-22 is arranged between the head rod 2-21 and the tail rod 2-23. In this embodiment, the head rod 2-21, the intermediate rod 2-22 and the tail rod 2-23 are formed integrally. The head rod 2-21 is in the shape of a triangular plate on the whole and located in a same plane as the cam 2-1, such that the head rod 2-21 is kept in contact with the cam 2-1 to the maximum extent. Because an end, away from the intermediate rod 2-22, of the tail rod 2-23 needs to be in contact with both the first inductive sensor 2-3 and the elastic structure, the tail rod 2-23 is L-shaped. In this embodiment, the elastic structure is a spring, and a columnar hole matched with the spring is formed in the end of the tail rod 2-23.

Wherein, the motor stop structure further includes a second inductive sensor 2-4, the second inductive sensor 2-4 is arranged corresponding to a trigger 2-7 of the nail gun and used for sensing the press state of the trigger 2-7 to determine whether the motor 2-62 needs to be stop. For example, when the trigger 2-7 is released, the second inductive sensor 2-4 works together with the first inductive sensor 2-3 to control the motor 2-62 to stop at the set angle. The second inductive sensor 2-4 is also connected to the control chip in the motor stop structure. The trigger 2-7 in the nail gun is rotatably arranged in the shell 1 of the nail gun, and a spring is arranged between the trigger 2-7 and the shell 1.

The first inductive sensor 2-3 and the second inductive sensor 2-4 are both push switches.

A nail gun includes the motor stop structure and further includes a nail shooting structure 2-6 and a shell 1, wherein the nail shooting structure 2-6 includes a firing pin 31, a motor 2-62, a piston 2-63, a transmission gear set 2-64 and a cylinder barrel 2-65; the firing pin 31, the motor 2-62, the piston 2-63, the gear transmission set 2-64 and the cylinder barrel 2-65 are arranged in the shell 1, and the transmission gear set 2-64 is connected to the motor 2-62 and the firing pin 31 to realize transmission connection between the motor 2-62 and the firing pin 31; the cylinder barrel 2-65 is arranged at an end, away from the motor 2-62, of the firing pin 31, and the piston 2-63 connected to the firing pin 31 is arranged in the cylinder barrel 2-65; the control chip, the cam 2-1, the connecting rod 2-2 and the first inductive sensor 2-3 in the motor stop structure are arranged in the shell 1; the cam 2-1 in the motor stop structure is arranged on a shaft of the motor 2-62.

In the implementation process, the motor stop structure for a nail gun includes the cam 2-1, the connecting rod 2-2 and other structures, such that the rotation angle of the motor 2-62 can be sensed to obtain the position of the firing pin 31 in the nail gun, and the firing pin 31 can be controlled to stop at a set position; the head rod 2-21 of the connecting rod 2-2 is in the shape of a triangular plate and located in the same plane as the cam 2-1, such that the head rod 2-21 can be kept in contact with the cam 2-1 to the maximum extent, and the load capacity of the head rod 2-21 can be improved to ensure that the head rod 2-21 is unlikely to be damaged when reciprocating quickly with the cam 2-1; the second inductive sensor 2-4 is arranged to sense the press state of the trigger 2-7 to determine whether the motor 2-62 needs to be stopped; the first inductive sensor 2-3 and the second inductive sensor 2-4 are used to count the number of revolutions of the motor 2-62 and the number of pulls of the trigger 2-7 respectively, and the number of the revolutions of the motor 2-62 is compared with the number of pulls of the trigger 2-7 to determine whether a nail gets stuck; when a nail gets stuck, the motor 2-62 will stop, the number of trigger times of the first inductive sensor 2-3 will remain unchanged, and the number of trigger times of the second inductive sensor 2-4 will increase with the increase in the number of pulls of the trigger 2-7, such that it can be known that a nail gets stuck.

### Embodiment 3

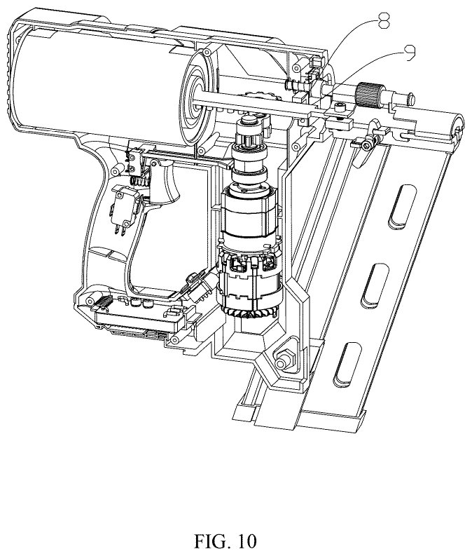

As shown in FIG. 10, this embodiment is obtained based on an improvement on Embodiment 2. Wherein, a motor stop structure for a nail gun includes a third inductive sensor 2-8, a sensing block 2-9 and a second inductive sensor 2-4, wherein the second inductive sensor 2-4 is arranged at the same position and in the same way as the second inductive sensor 2-4 in Embodiment 2; the third inductive sensor 2-8 is arranged corresponding to the sensing block 2-9, and the sensing block 2-9 is located on a firing pin of the nail gun. The third inductive sensor 2-8 is a photoelectric sensor or a Hall sensor. In this embodiment, the third inductive sensor 2-8 is a photoelectric sensor.

In the implementation process, the third inductive sensor 2-8 is arranged to sense the position of the sensing block 2-9 to control the position of the firing pin, thus ensuring that the firing pin is located at a set position when the nail gun is started and stopped.

### Embodiment 4

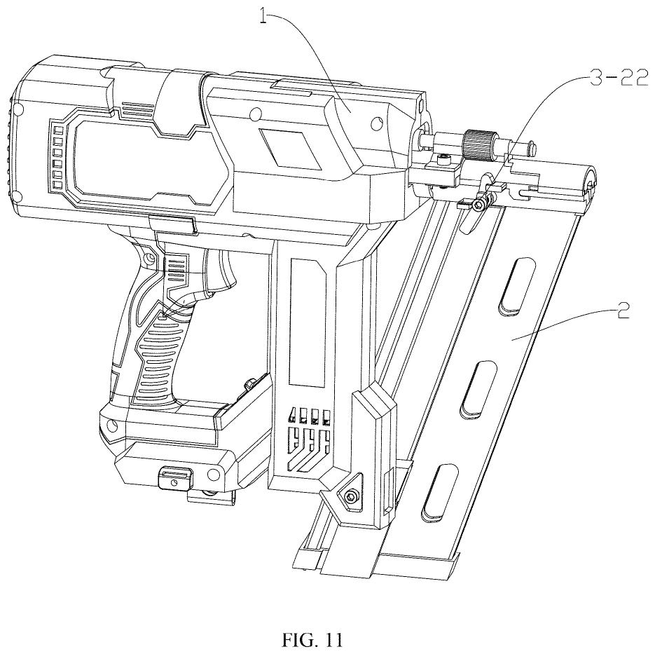

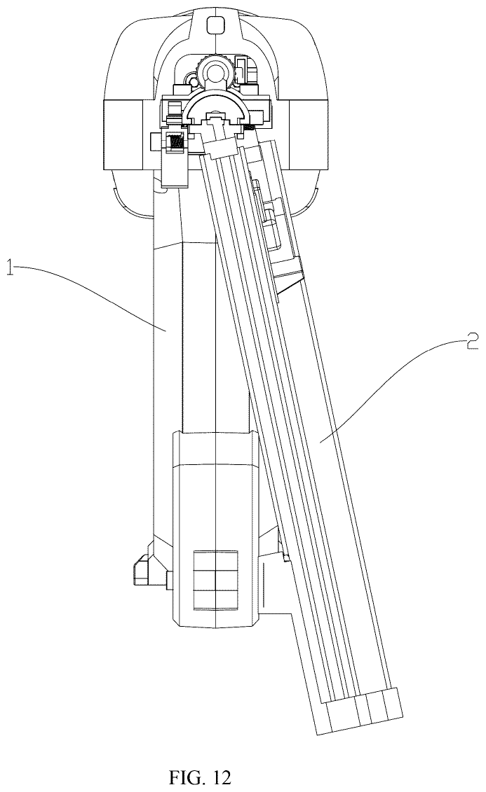

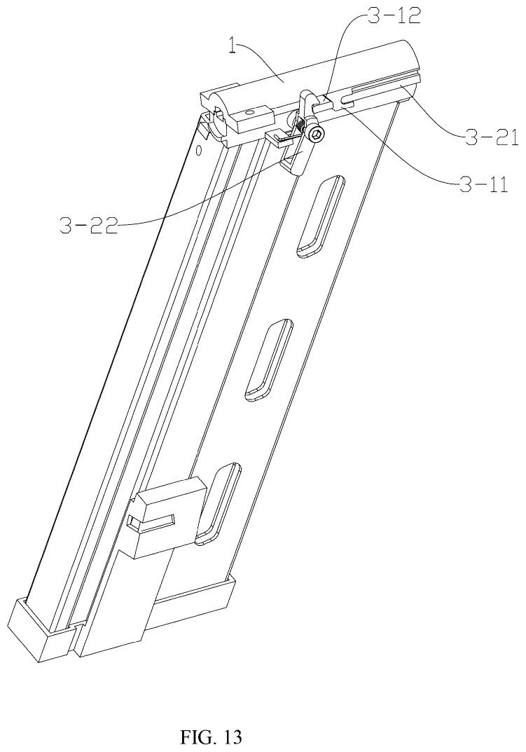

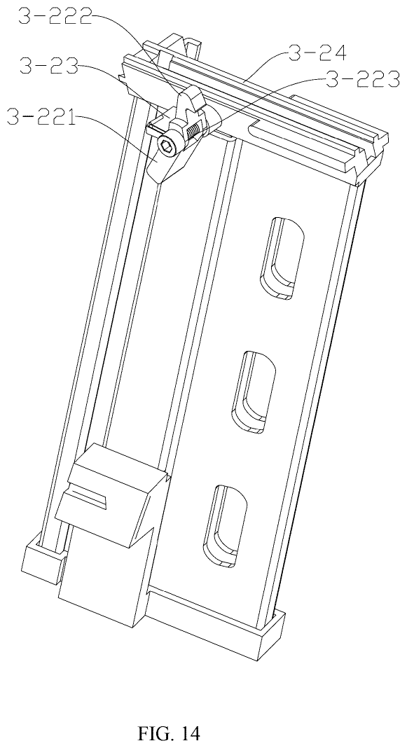

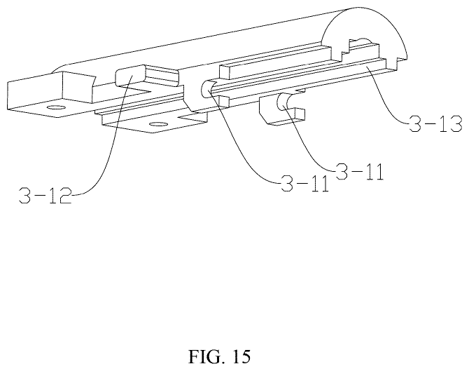

As shown in FIGS. 11-15, a nail gun with a magazine easy to assemble and disassemble includes a shell 1 and a magazine 2, wherein the magazine 2 is detachably connected to the shell 1; the magazine 2 is in the shape of a rectangular box on the whole; a hollow structure for storing a row of nails is arranged in the magazine 2; the top of the magazine 2 is connected to the shell 1; first clamping blocks 3-21 extending outwards are arranged on two sides of the top of the magazine 2, and a first clamping groove 3-11 corresponding to the first clamping blocks 3-21 is formed in the shell 1. In this embodiment, the first clamping groove 3-11 is divided into two portions which are respectively matched with the first clamping blocks 3-21 on the two sides of the magazine 2. An opening of the first clamping groove 3-11 faces a front side or a back side. In this embodiment, the opening of the first clamping groove 3-11 faces the front side. It should be noted that the front side refers to a nail shooting direction of the nail gun, and the back side refers to a direction opposite to the nail shooting direction of the nail gun. A clamping structure 3-22 is arranged on an outer side of the magazine 2 and includes a shifter 3-221 rotatably connected to the magazine 2, and a torsion spring 3-223, wherein the torsion spring 3-223 is arranged between the shifter 3-221 and the magazine 2; a second clamping block 3-12 corresponding to the shifter 3-221 is arranged on the shell 1. In this embodiment, the torsion spring 3-223 applies a force towards the second clamping block 3-12 to the shifter 3-221, such that the shifter 3-221 can be clamped on the second clamping block 3-12 without an external force.

The first clamping blocks 3-21 are strip-shaped, and an opening matched with the first clamping blocks 3-21 is formed in the first clamping groove 3-11, such that the first clamping blocks 3-21 can be inlaid in the first clamping groove 3-11 to be clamped in the first clamping groove 3-11. In this embodiment, ends, facing the first clamping groove 3-11, of the first clamping blocks 3-21 are configured as arc surfaces, such that the first clamping blocks 3-21 can be easily pushed into the first clamping groove 3-11 to be clamped in the first clamping groove 3-11.

The shifter 3-221 is in the shape of a long plate on the whole, a through-hole is formed in a portion close to the middle of the shifter 3-221, and the shifter 3-221 is rotatably connected to the magazine 2 by means of the through-hole; wherein, one end of the shifter 3-221 is clamped on the second clamping block 3-12, and the other end of the shifter 3-221 is to be shifted. A barb 3-222 is arranged at the end, close to the second clamping block 3-12, of the shifter 3-221, wherein the barb 3-222 is in contact with an upper surface of the second clamping block 3-12, such that the situation where the shifter 3-221 is separated from the second clamping block 3-12 due to downward movement of the magazine 2 is avoided.

When the magazine 2 is connected to the shell 1 of the nail gun, the shifter 3-221 in the clamping structure 3-22, the second clamping block 3-12, the first clamping groove 3-11 and the first clamping blocks 3-21 are sequentially arranged from back to front. Wherein, under the action of the torsion spring 3-223, the shifter 3-221 applies a forward force to the second clamping block 3-12 to push the shell 1 to move forwards, and the first clamping blocks 3-21 on the magazine 2 are inlaid in the first clamping groove 3-11, with the opening facing forwards, in the shell 1, such that the magazine 2 is clamped and locked on the shell 1.

A bump 3-23 matched with the torsion spring 3-223 is arranged on an outer side of the magazine 2. It should be noted that when the magazine 2 is connected to the shell 1, the clamping structure 3-22 is located between the bump 3-23 and the second clamping block 3-12, such that the torsion spring 3-223 can push the shifter 3-221 to move towards the second clamping block 3-12. In some other embodiments, an end, away from the shifter 3-221, of the torsion spring 3-223 may be directly connected to a hole structure or groove structure formed in the outer side of the magazine 2.

Protrusive elongated blocks 3-24 are arranged on an upper surface of the magazine 2. In this embodiment, two elongated blocks 3-24 are arranged on the upper surface of the magazine 2 and respectively located on two sides of a nail outlet of the magazine 2. Second clamping grooves 3-13 matched with the elongated blocks 3-24 are formed in the bottom of the shell 1, and the elongated blocks 3-24 are inlaid in the second clamping grooves 3-13 to prevent the magazine 2 from shaking leftwards and rightwards.

An elongated hole connected to the hollow structure in the magazine 2 is formed in a side face of the magazine 2. The number of remaining nails in the magazine 2 can be observed by means of the through-hole.

In the implementation process, the clamping structure 3-22 and the first clamping blocks 3-21 are arranged on the magazine 2 and respectively matched with the second clamping block 3-12 and the first clamping groove 3-11 on the shell 1, such that the magazine 1 is detachably connected to the shell 1, and the magazine 2 can be easily separated from the shell 1 by rotating the shifter 3-221 in the clamping structure 3-22; the barb 3-222 is arranged at the end, close to the second clamping block 3-12, of the shifter 3-221 in the clamping structure 3-22, such that the situation where the shifter 3-221 is separated from the second clamping block 3-12 due to downward movement of the magazine 2 is avoided; the elongated blocks 3-24 arranged on the upper surface of the magazine 2 are matched with the second clamping grooves 3-13 in the shell 1 to further clamp the magazine 2 on the shell 1, such that the magazine 2 is prevented from shaking leftwards and rightwards.

One specific example of the invention is described above and is not intended to limit the invention in any form. Obviously, those skilled in the art, after understanding of the contents and principle of the invention, can make various modifications and transformations in form and details without departing from the principle and structure of the invention, and all these modifications and transformations made based on the concept of the invention should also fall within the protection scope of the claims of the invention.

What is claimed is:

1 . A no-nail protection structure for a nail gun, comprising a shell, a magazine, and a nail shooting portion, wherein the nail shooting portion is being-arranged in the shell and comprises a firing pin and a power source, the firing pin is connected to the power source and the magazine is detachably arranged on the shell, wherein the no-nail protection structure further comprises a protection portion; the protection portion comprises a trigger element, a first spring, a trigger switch, and a clamping piece wherein the trigger element is slidably arranged in a vicinity of a nail shooting opening in the shell; the first spring is arranged between the trigger element and the shell the trigger switch is arranged on a sliding path of the trigger element; the trigger switch is connected to the power source; the clamping piece is arranged in the magazine and an elastic element is arranged between the clamping piece and the magazine an anti-dry firing nail block is arranged at a top of the clamping piece and a clamping portion corresponding to the anti-dry firing nail block is arranged on the trigger element.

2-28. (canceled)

29. The no-nail protection structure for the nail gun according to claim 1, wherein the trigger element comprises a safety lever and an adjusting block; the safety lever is arranged on the shell, and the adjusting block is arranged at a position adjacent to the nail shooting opening of the shell; the adjusting block is disposed around the safety lever by means of a threaded structure; the adjusting block is semicircular and arranged on an outer side of the nail shooting opening of the shell of the nail gun and slides along an outer wall of the nail shooting opening; the first spring is disposed around an outer side of the safety lever.

30. The no-nail protection structure for the nail gun according to claim 1, wherein a nail pusher configured for pushing nails is arranged in the magazine, the elastic element is arranged between the nail pusher and the magazine, and the clamping piece is fixedly arranged on the nail pusher; the elastic element is a coil spring or a second spring; at least one through-hole for observing a number of remaining nails in the magazine is formed in a side face of the magazine; the trigger switch is a touch switch or a photoelectric switch.

31. A nail gun, comprising a motor stop structure for the nail gun, a nail shooting structure, and a shell, wherein the nail shooting structure comprises a firing pin, a motor, a piston, a transmission gear set, and a cylinder barrel; the firing pin, the motor, the piston, the transmission gear set, and the cylinder barrel are arranged in the shell, the transmission gear set is connected to the motor and the firing pin, the cylinder barrel is arranged at an end, away from the motor, of the firing pin, and the piston connected to the firing pin is arranged in the cylinder barrel; a control chip, a cam, a connecting rod, and a first inductive sensor in the motor stop structure are arranged in the shell; the cam in the motor stop structure is arranged on a shaft of the motor.

32. The nail gun according to claim 31, wherein the motor stop structure for the nail gun comprises the control chip, the cam, the connecting rod, and the first inductive sensor; wherein the cam is arranged on the shaft of the motor in the nail gun; the connecting rod is arranged between the cam and the first inductive sensor; the first inductive sensor and the control chip are arranged in the shell of the nail gun, and the first inductive sensor is connected to the control chip; an elastic structure for restoring the connecting rod is arranged between the connecting rod and the shell of the nail gun.

33. The nail gun according to claim 32, wherein the connecting rod comprises a head rod, an intermediate rod, and a tail rod; wherein the intermediate rod is arranged between the head rod and the tail rod, and the head rod, the intermediate rod and the tail rod are formed integrally.

34. The nail gun according to claim 33, wherein the head rod is in a shape of a triangular plate on the whole and located in a same plane as the cam; a columnar hole matched with a spring is formed in a first end of the tail rod; the tail rod is L-shaped, and a second end, away from the intermediate rod, of the tail rod is in contact with the first inductive sensor and the elastic structure.

35. The nail gun according to claim 31, wherein the motor stop structure for the nail gun comprises a third inductive sensor and a sensing block; the third inductive sensor is arranged corresponding to the sensing block, and the sensing block is located on the firing pin of the nail gun; the third inductive sensor is a photoelectric sensor or a Hall sensor.

36. The nail gun according to claim 31, further comprising a trigger, wherein the trigger is rotatably arranged in the shell, a spring is arranged between the trigger and the shell, and a second inductive sensor is arranged corresponding to the trigger of the nail gun.

37. The nail gun according to claim 36, further comprising the second inductive sensor for counting a number of pulls of the trigger of the nail gun.

38. A nail gun with a magazine easy to assemble and disassemble, comprising a shell and the magazine, wherein the magazine is detachably connected to the shell and in a shape of a rectangular box on the whole; a hollow structure for storing a row of nails is arranged in the magazine; a top of the magazine is connected to the shell; first clamping blocks extending outwards are arranged on two sides of the top of the magazine, and a first clamping groove corresponding to the first clamping blocks is formed in the shell; an opening of the first clamping groove faces a front side or a back side; a clamping structure is arranged on an outer side of the magazine; the clamping structure comprises a shifter and a torsion spring, wherein the shifter is rotatably connected to the magazine, and the torsion spring is arranged between the shifter and the magazine; a second clamping block corresponding to the shifter is arranged on the shell.

39. The nail gun with the magazine easy to assemble and disassemble according to claim 38, wherein the first clamping blocks are strip-shaped, and the opening matched with the first clamping blocks is formed in the first clamping groove; ends, facing the first clamping groove, of the first clamping blocks are configured as arc surfaces; the opening of the first clamping groove faces forwards.

40. The nail gun with the magazine easy to assemble and disassemble according to claim 38, wherein the shifter is in a shape of a long plate on the whole, and a through-hole is formed in a portion adjacent to a middle of the shifter; the shifter has a first end clamped on the second clamping block as well as a second end to be shifted; a barb is arranged at the first end, adjacent to the second clamping block, of the shifter, and the barb is in contact with an upper surface of the second clamping block.

41. The nail gun with the magazine easy to assemble and disassemble according to claim 38, wherein a bump matched with the torsion spring is arranged on the outer side of the magazine, and the clamping structure is arranged between the bump and the second clamping block; an end, away from the shifter, of the torsion spring is directly connected to a hole structure or a groove structure formed in the outer side of the magazine; two protrusive rectangular elongated blocks are arranged on an upper surface of the magazine and respectively located on two sides of a nail outlet of the magazine, second clamping grooves matched with the two protrusive rectangular elongated blocks are formed in a bottom of the shell, and the two protrusive rectangular elongated blocks are inlaid in the second clamping grooves; an elongated hole connected to the hollow structure in the magazine is formed in a side face of the magazine.

42. The nail gun according to claim 32, further comprising a trigger, wherein the trigger is rotatably arranged in the shell, a spring is arranged between the trigger and the shell, and a second inductive sensor is arranged corresponding to the trigger of the nail gun.

43. The nail gun according to claim 33, further comprising a trigger, wherein the trigger is rotatably arranged in the shell, a spring is arranged between the trigger and the shell, and a second inductive sensor is arranged corresponding to the trigger of the nail gun.

44. The nail gun according to claim 34, further comprising a trigger, wherein the trigger is rotatably arranged in the shell, the spring is arranged between the trigger and the shell, and a second inductive sensor is arranged corresponding to the trigger of the nail gun.

45. The nail gun according to claim 35, further comprising a trigger, wherein the trigger is rotatably arranged in the shell, a spring is arranged between the trigger and the shell, and a second inductive sensor is arranged corresponding to the trigger of the nail gun.

46. The nail gun according to claim 42, further comprising the second inductive sensor for counting a number of pulls of the trigger of the nail gun.

47. The nail gun according to claim 43, further comprising the second inductive sensor for counting a number of pulls of the trigger of the nail gun.
